(19) United States
(12) Patent Application Publication
(10) Pub. No.: US 2014/0293594 A1
(43) Pub. Date: Oct. 2, 2014

(54) LAMP STRUCTURE

(71) Applicant: Lextar Electronics Corporation, Hsinchu (TW)

(72) Inventor: Wen-Lung SU, Hsinchu County (TW)

(73) Assignee: Lextar Electronics Corporation, Hsinchu (TW)

(21) Appl. No.: 14/069,393

(22) Filed: Nov. 1, 2013

(30) Foreign Application Priority Data
Apr. 1, 2013 (TW) 102111703

(51) Int. Cl. F21V 7/00; F21V 29/00; F21K 99/00

(52) U.S. Cl. CPC F21V 7/00; F21K 9/50; F21V 29/22
USPC 362/217.05; 362/297; 362/294

(57) ABSTRACT

A lamp structure includes a base, a side-emitting light source, first and second reflecting portions. The base includes a central protrusion portion extending from the base. The side-emitting light source is disposed on a side surface of the central protrusion portion and configured to emit a light beam. The first reflecting portion includes a first reflective curved surface, and a portion of the light beam is reflected thereby and then is directly emitted out. The first reflecting portion is disposed between the central protrusion portion and the second reflecting portion. The second reflecting portion includes a second reflective curved surface adjacent to the first reflective curved surface, and the other portion of the light beam is reflected thereby and then is directly or indirectly emitted out. The first reflective curved surface has a radius of curvature less than that of the second reflective curved surface.

### RELATED APPLICATIONS

This application claims priority to Taiwan Application Serial Number 102111703, filed Apr. 1, 2013; which is herein incorporated by reference.

### BACKGROUND

1. Technical Field

The present disclosure relates to a lamp structure, and more particularly, to a lamp structure for uniformly emitting light.

2. Description of Related Art

A light-emitting diode (LED) emits light that is transformed from electrical energy. The LED is mainly made of semiconductor materials including a p-type semiconductor containing more positively charged holes and an n-type semiconductor containing more negatively charged electrons, A PN junction is formed at the junction between the p-type and n-type semiconductors. When a voltage is applied to positive and negative electrodes of the LED, the electron and the hole are combined so as to emit light.

The LED has been widely applied in a variety of lamp structures since it has advantages of long lifetime, low temperature and high-energy efficiency. FIG. 1 is a cross-sectional view of a conventional lamp structure. The lamp structure includes two light sources 60 and two reflective sheets 70. The light beams emitted from the two light sources 60 are respectively emitted on the two reflective sheets 70 and then reflected and going out. However, the junction between the two reflective sheets 70 is not easy to reflect light, such that a dark band may be generated at a central region; in other words, the lamp structure emits light non-uniformly. Therefore, the conventional lamp structure in the technical field has the problem of emitting light non-uniformly.

### SUMMARY

One aspect of the present disclosure provides lamp structure including a base, a side-emitting light source, a first reflecting portion and a second reflecting portion. The base includes a central protrusion portion extending from the base. The side-emitting light source is disposed on a side surface of the central protrusion portion and configured to emit a light beam. The first reflecting portion is adjacent to the central protrusion portion, in which the first reflecting portion includes a first reflective curved surface, and a portion of the light beam is reflected by the first reflective curved surface and then is directly emitted out in an light outgoing direction, and the light outgoing direction is substantially parallel to an axial direction of the central protrusion portion. The first reflecting portion is disposed between the central protrusion portion and the second reflecting portion, in which the second reflecting portion includes a second reflective curved surface adjacent to the first reflective curved surface, and the other portion of the light beam is reflected by the second reflective curved surface and then is directly or indirectly emitted out. The first reflective curved surface has a radius of curvature less than a radius of curvature of the second reflective curved surface.

According to one embodiment of the present disclosure, the radius of curvature of the first reflective curved surface is in a range from 2 cm to 10 cm.

According to one embodiment of the present disclosure, a lowest point of the first reflective curved surface of the first reflecting portion is higher than a lowest point of the second reflective curved surface of the second reflecting portion.

According to one embodiment of the present disclosure, the side-emitting light source is higher than a highest point of the first reflective curved surface of the first reflecting portion.

According to one embodiment of the present disclosure, a ratio of a distance between a lowest point of the first reflective curved surface and the side surface of the central protrusion portion to a distance between a highest point of the first reflective curved surface and the side surface of the central protrusion portion is lower than or equal to 0.7.

According to one embodiment of the present disclosure, an included angle between the portion of the light beam and a direction substantially vertical to the axial direction of the central protrusion portion is greater than or equal to a specific angle of 45°-60°.

According to one embodiment of the present disclosure, a highest point of the first reflective curved surface is disposed on an extension line with an included angle of 45°-60° to a main light emitting direction of the side-emitting light source.

According to one embodiment of the present disclosure, a lowest point of the first reflective curved surface is disposed on an extension line with an included angle greater than 60° to a main light emitting direction of the side-emitting light source.

According to one embodiment of the present disclosure, a tangent line of a lowest point of the first reflective curved surface of the first reflecting portion is substantially parallel to a direction vertical to the axial direction of the central protrusion portion.

According to one embodiment of the present disclosure, the first reflecting portion further comprises a back surface connected to a highest point of the first reflective curved surface.

According to one embodiment of the present disclosure, the second reflecting portion further comprises a third reflective curved surface connected to the second reflective curved surface, and the second reflective curved surface is disposed between the first reflective curved surface and the third reflective curved surface, and the third reflective curved surface has a radius of curvature greater than the radius of curvature of the second reflective curved surface.

According to one embodiment of the present disclosure, the side-emitting light source is a linear-shaped light source or a ring-shaped light source.

According to one embodiment of the present disclosure, the central protrusion portion is a longitudinal object extending in a direction vertical to the axial direction of the central protrusion portion, and the side-emitting light source comprises a plurality of light-emitting diodes disposed on two opposite longitudinal sides of the longitudinal object.

According to one embodiment of the present disclosure, the light-emitting diodes are arranged in a linear form along the extending direction of the longitudinal object.

According to one embodiment of the present disclosure, the central protrusion portion is a cylinder extending in the axial direction of the central protrusion portion, and the side-emitting light source comprises a plurality of light-emitting diodes disposed on a side surface of the cylinder.

According to one embodiment of the present disclosure, the light-emitting diodes are arranged in a ring form and surrounding the central protrusion portion.

According to one embodiment of the present disclosure, the base further comprises a heat spreader connected to the central protrusion portion, and the heat spreader comprises a plurality of heat dissipation fins spaced apart.

According to one embodiment of the present disclosure, the heat spreader of the base and the central protrusion portion are integrally formed.

According to one embodiment of the present disclosure, the lamp structure further includes a high reflectivity layer covering the first reflective curved surface, the second reflective curved surface or a combination thereof.

### BRIEF DESCRIPTION OF THE DRAWINGS

The disclosure may be more fully understood by reading the following detailed description of the embodiment, with reference made to the accompanying drawings as follows:

FIG. 1 is a cross-sectional view of a conventional lamp structure;

FIG. 2 is a cross-sectional view of a lamp structure according to one embodiment of the present disclosure;

FIG. 3 is a cross-sectional view of the side-emitting light source, the first reflective curved surface and the second reflective curved surface of FIG. 2;

FIG. 4 is a cross-sectional view of the side-emitting light source, the first reflective curved surface and the second reflective curved surface according to another embodiment of the present disclosure;

FIG. 5 is a cross-sectional view of a lamp structure according to another embodiment of the present disclosure;

FIG. 6 is a stereoscopic view of a base according to one embodiment of the present disclosure;

FIG. 7 is a schematic diagram of a light bar according to one embodiment of the present disclosure;

FIG. 8 is a schematic diagram of a light bar according to another embodiment of the present disclosure; and

FIG. 9 is a stereoscopic view of a base according to another embodiment of the present disclosure.

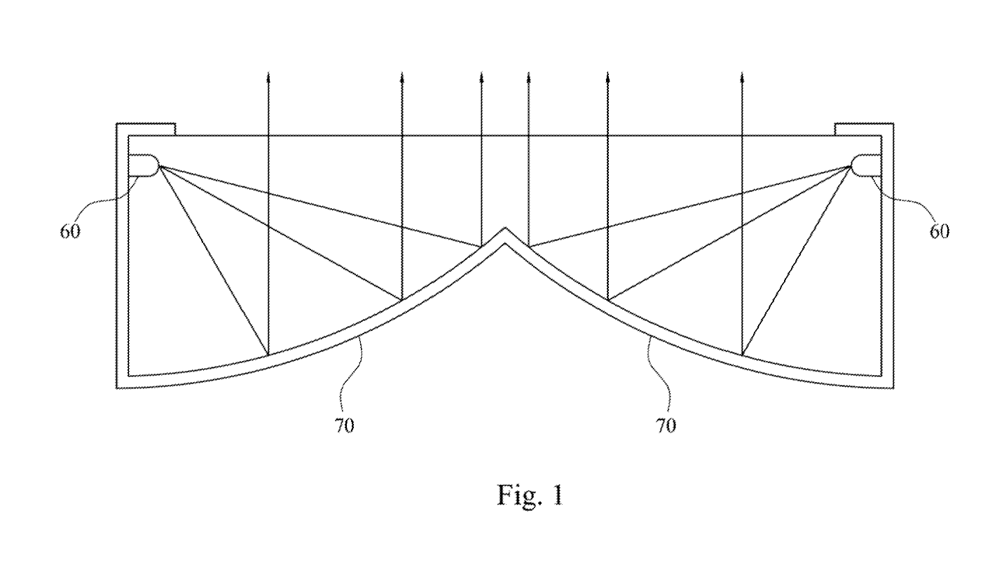

### DETAILED DESCRIPTION

The present disclosure is described by the following specific embodiments. Those with ordinary skill in the arts can readily understand the other advantages and functions of the present invention after reading the disclosure of this specification. The present disclosure can also be implemented with different embodiments. Various details described in this specification can be modified based on different viewpoints and applications without departing from the scope of the present disclosure.

As used herein, the singular forms and “the” include plural referents unless the context clearly dictates otherwise. Therefore, reference to, for example, a reflective curved surface includes aspects having two or more such reflective curved surfaces, unless the context clearly indicates otherwise.

Reference will now be made in detail to the embodiments of the present disclosure, examples of which are illustrated in the accompanying drawings. Wherever possible, the same reference numbers are used in the drawings and the description to refer to the same or like parts.

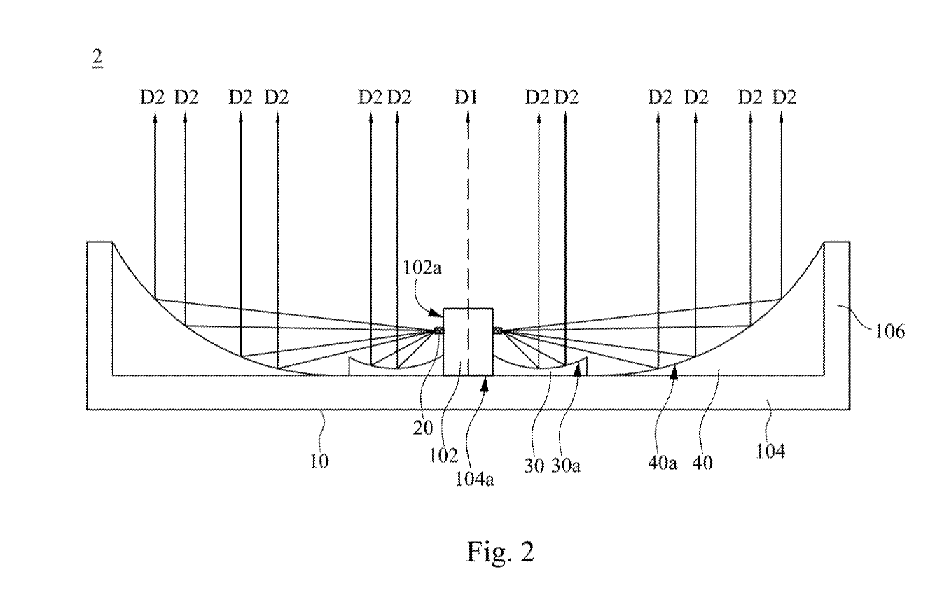

FIG. 2 is a cross-sectional view of a lamp structure 2 according to one embodiment of the present disclosure. The lamp structure 2 includes a base 10, a side-emitting light source 20, a first reflecting portion 30 and a second reflecting portion 40.

The base 10 includes a central protrusion portion 102 extending outwardly from the base 10. Specifically, in one embodiment, as shown in FIG. 2, the base 10 includes the central protrusion portion 102, a bottom base 104 and a frame 106. The frame 106 is disposed at the edge of the bottom base 104. The central protrusion portion 102 is extending outwardly from a center of the base 104. Specifically, the central protrusion portion 102 is extending in an axial direction D1 thereof substantially vertical to a surface 104a of the bottom base 104.

The side-emitting light source 20 is disposed on a side surface 102a of the central protrusion portion 102 and configured to emit a light beam from the center of the base 10 to the surrounding. For instance, the side-emitting light source 20 may be a light-emitting diode (LED), such as a top-view LED.

The first reflecting portion 30 is adjacent to the central protrusion portion 102. The first reflecting portion 30 includes a first reflective curved surface 30a. A portion of the light beam is reflected by the first reflective curved surface 30a and is then directly emitted out. In the embodiment, a light outgoing direction D2 is substantially parallel to the axial direction D1 of the central protrusion portion 102. Hence, the central region has sufficient light extraction efficiency so as to resolve the problem of easily forming a dark band in the central region in the technical field.

The second reflecting portion is away from the central protrusion portion 102. Specifically, the first reflecting portion 30 is disposed between the second reflecting portion 40 and the central protrusion portion 102. The second reflecting portion 40 includes a second reflective curved surface 40a adjacent to the first reflective curved surface 30a. The other portion of the light beam is reflected by the second reflective curved surface 40a and is then directly or indirectly emitted out.

Particularly, the first reflective curved surface 30a has a radius of curvature less than a radius of curvature of the second reflective curved surface 40a. That is, the first reflective curved surface 30a has a curvature greater than that of the second reflective curved surface 40a. The light irradiating on the first reflective curved surface 30a is reflected once and then emitted out along the light outgoing direction D2 so as to increase the light extraction efficiency of the central region. The light irradiating on the second reflective curved surface 40a is reflected once or more times and then emitted out along the light outgoing direction D2 so as to make a softer outgoing light. In a specific embodiment, the radius of the curvature of the first reflective curved surface 30a is in a range from 2 cm to 10 cm.

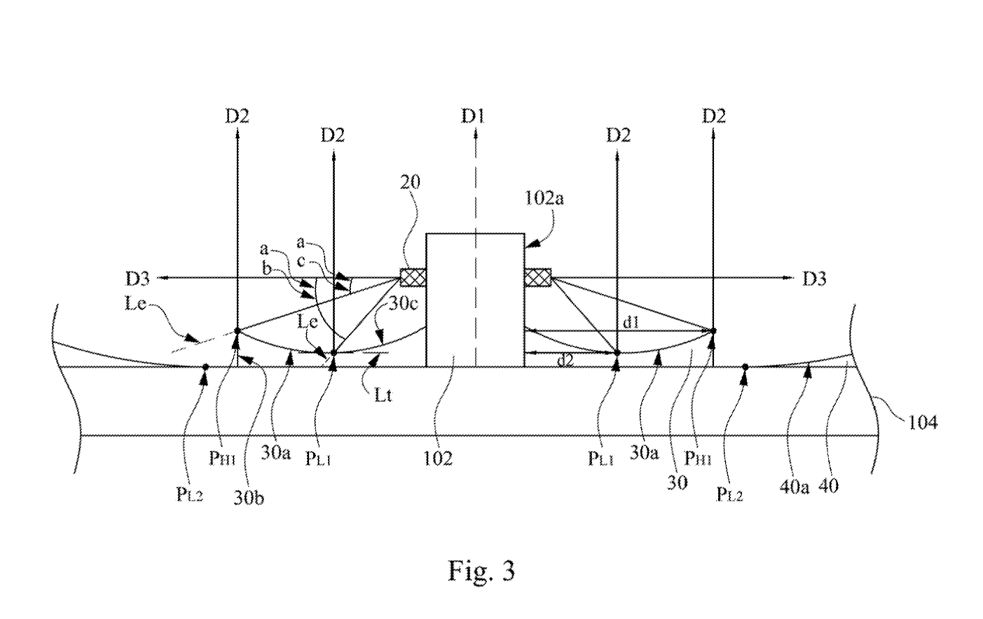

The relative position of the first reflective curved surface 30a, the second reflective curved surface 40a and the side-emitting light source 20 of the embodiment will be described below in detail. FIG. 3 is a cross-sectional view of the side-emitting light source 20, the first reflective curved surface 30a and the second reflective curved surface 40a of FIG. 2. The first reflective curved surface 30a has a lowest point P_{L1} and a highest point P_{H1}. The lowest point P_{L1} is adjacent to the central protrusion portion 102, and the highest point P_{H1} is away from the central protrusion portion 102. The second reflective curved surface 40a has a lowest point P_{L2} adjacent to the highest point P_{H1} of the first reflective curved surface 30a. The lowest point P_{L2} is lower than the highest point P_{H1} and the lowest point P_{L1} of the first reflective curved surface 30a. In addition, the side-emitting light source 20 is higher than the highest point P_{H1} of the first reflective curved surface 30a.

There is a distance d2 between the lowest point P_{L1} and the side surface 102a of the central protrusion portion 102. There is a distance d1 between the highest point P_{H1} and the side surface 102a of the central protrusion portion 102. In one specific embodiment, the ratio (d2/d1) of the distance d2 to the distance d1 is less than or equal to 0.7.

The relationship between the first reflective curved surface 30a and the light irradiating thereon will be described below in detail, as shown in FIG. 3. For the top-view LED, a main light-emitting direction D3 is substantially perpendicular to the axial direction D1. There is an included angle a between the main light-emitting direction D3 and the light direction. When the included angle a is greater than or equal to a specific angle (i.e., angle c), the light will be emitted on the first reflective curved surface 30a. In one specific embodiment, the specific angle (i.e., angle c) is in a range from 45° to 60°. For a specific example, when the angle c is 45°, the light having the included angle a greater than or equal to 45° will be emitted on the first reflective curved surface 30a. For another specific example, when the angle c is 60°, the light having the included angle a greater than or equal to 60° will be emitted on the first reflective curved surface 30a. In addition, the angle c can be regarded as an included angle between a connecting line between the highest point P_{H1} and the center of the side-emitting light source 20, and the main light-emitting direction D3. Therefore, the highest point P_{H1} should be disposed on an extension line Le with the included angle c of 45°-60°. In another aspect, an included angle b can be regarded as an included angle between a connecting line between the lowest point P_{L1} and the center of the side-emitting light source 20, and the main light-emitting direction D3. Therefore, the lowest point P_{L1} should be disposed on an extension line Le with the included angle b greater than 60°.

In one embodiment, a tangent line Lt of the lowest point P_{L1} is substantially parallel to the main light-emitting direction D3 vertical to the axial direction D1.

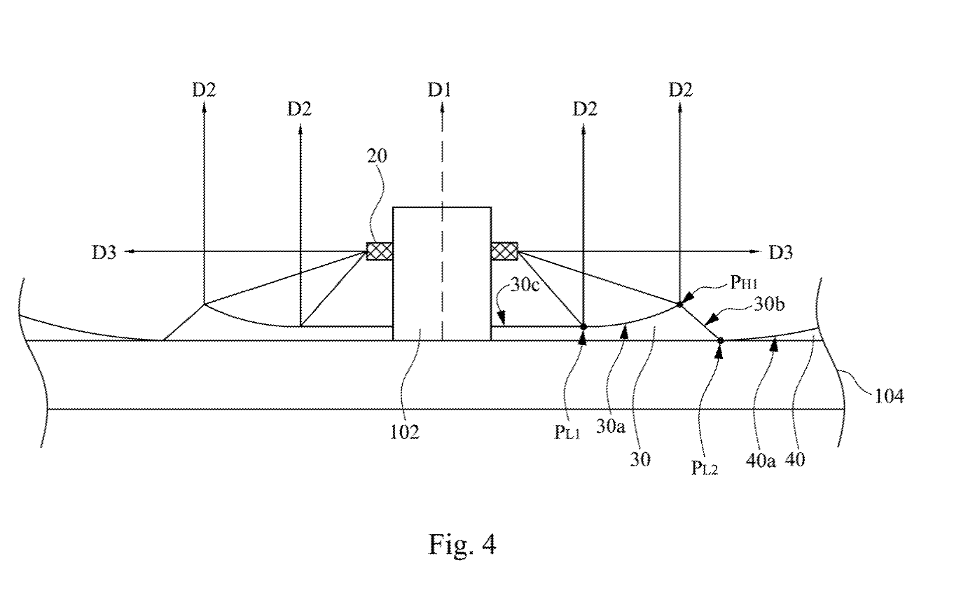

In one embodiment, as shown in FIG. 3, the first reflecting portion 30 further includes a back surface 30b connected to the highest point P_{H1} of the first reflective curved surface 30a but not connected to the lowest point P_{L2} of the second reflective curved surface 40a. The first reflecting portion 30 further includes a surface 30c connected to the side surface 102a of the central protrusion portion 102. In the embodiment illustrated in FIG. 3, the surface 30c is a curved surface. Since the light may not be emitted on the back surface 30b and the surface 30c, the configuration thereof can be adjusted. In another embodiment, as shown in FIG. 4, the back surface 30b is connected to the highest point P_{H1} and the lowest point P_{L2}, and the surface 30c is a flat surface.

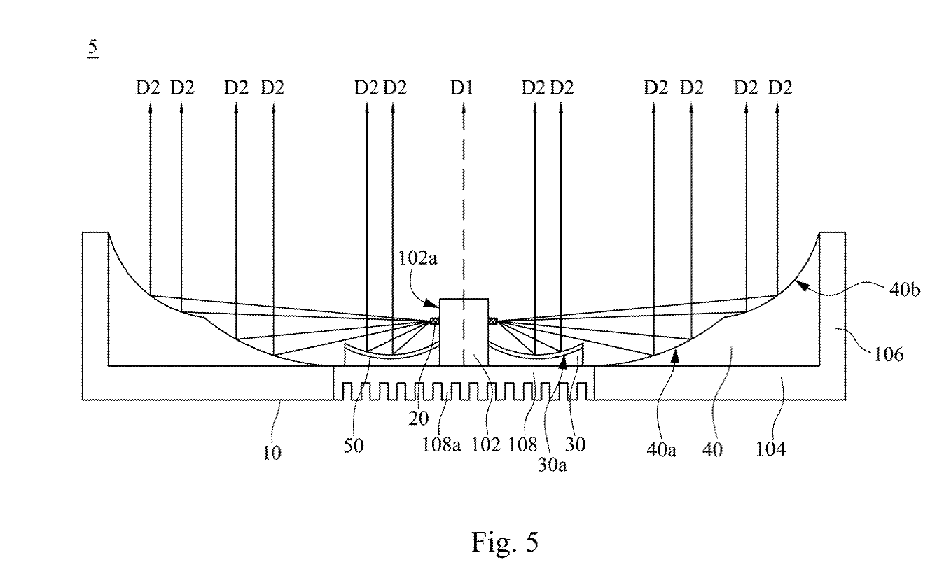

FIG. 5 is a cross-sectional view of a lamp structure 5 according to another embodiment of the present disclosure. The lamp structure 5 includes a base 10, a side-emitting light source 20, a first reflecting portion 30 and a second reflecting portion 40. The specific features of the side-emitting light source 20 and the first reflecting portion 30 shown in FIG. 5 can be the same as those of FIG. 2.

The base 10 includes a central protrusion portion 102, a bottom base 104, a frame 106 and a heat spreader 108. Particularly, the heat spreader 108 is connected to the central protrusion portion 102 and includes a plurality of heat dissipation fins 108a spaced apart. Therefore, heat generated by the side-emitting light source 20 can be dissipated to outside through the central protrusion portion 102 and the heat dissipation fins 108a of the heat spreader 108. For an example, the heat spreader 108 and the central protrusion portion 102 are integrally formed.

The second reflecting portion 40 includes a second reflective curved surface 40a and a third reflective curved surface 40b connected to the second reflective curved surface 40a. The second reflective curved surface 40a is disposed between the first reflective curved surface 30a and the third reflective curved surface 40b. Also, the third reflective curved surface 40b has a radius of curvature greater than that of the second reflective curved surface 40a. Of course, the person skilled in the art should understand that the second reflecting portion 40 of the embodiment of the present disclosure may include more reflective curved surfaces and not limited to the embodiment shown in FIG. 5.

Further, the lamp structure may further include a high reflectivity layer covering the first reflective curved surface 30a, the second reflective curved surface 40a or a combination thereof to enhance the reflection effect. As shown in FIG. 5, the high reflectivity layer 50 covers the first reflective curved surface 30a. Alternatively, in other embodiments, the first reflective curved surface 30a and/or the second reflective curved surface 40a are/is polished to enhance the reflection effect.

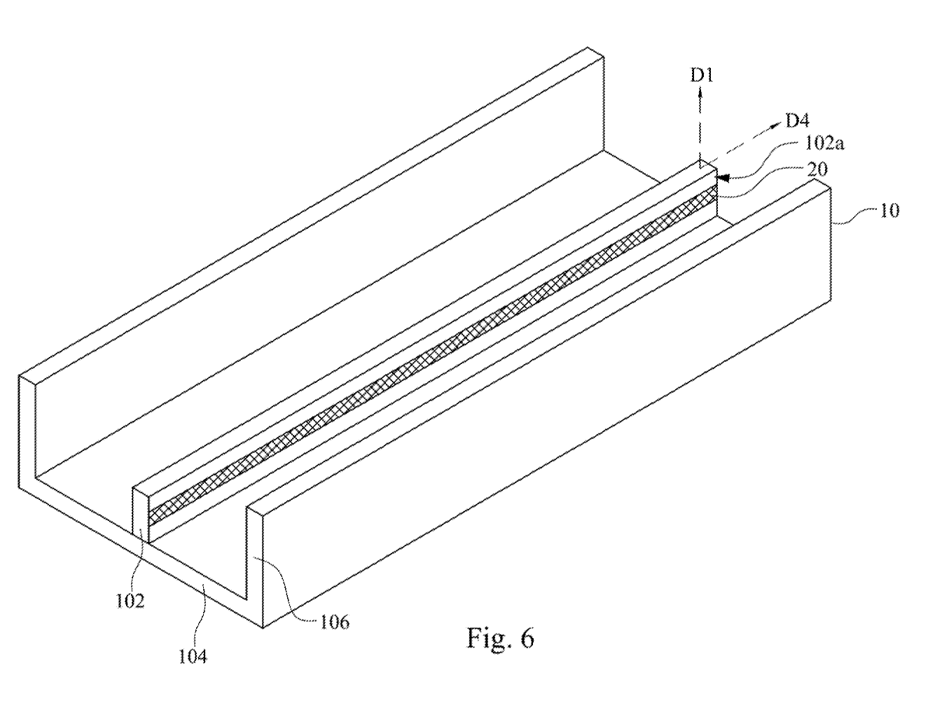

The side-emitting light source may be a linear-shaped light source or a ring-shaped light source. The term “linear-shaped light source” refers to a light source has a linear shape, such as a tube or LEDs arranged along a linear direction. The term “ring-shaped light source” refers to a light source being ring-shaped, such as an annular tube or LEDs arranged in a ring shape. FIG. 6 is a stereoscopic view of a base according to one embodiment of the present disclosure. In the embodiment shown in FIG. 6, the side-emitting light source 20 is a linear-shaped light source. The central protrusion portion 102 is a longitudinal object extending in a direction D4. The direction D4 is substantially vertical to the axial direction D1 of the central protrusion portion 102. The side-emitting light source 20 may include a plurality of LEDs (not shown) disposed on two opposite longitudinal sides 102a of the central protrusion portion 102.

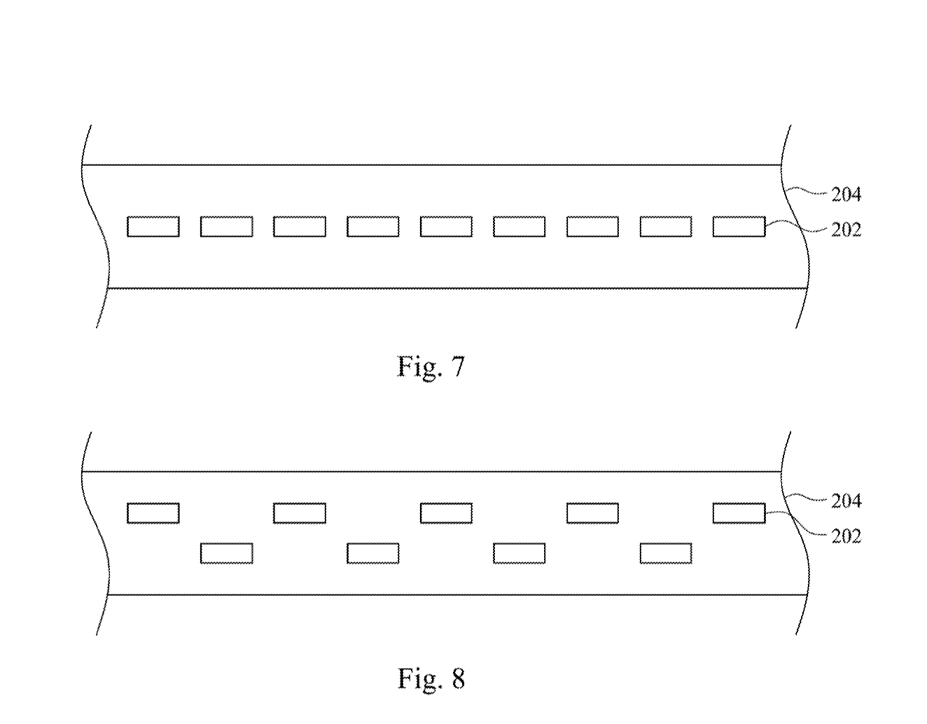

The LEDs may be disposed on a substrate and constitute a light bar. In one embodiment, as shown in FIG. 7, the LEDs 202 are disposed on the substrate 204 and arranged in a linear form. In another embodiment, as shown in FIG. 8, the LEDs 202 are staggered. A LED module (not shown) may include one or more light bars. The central protrusion portion 102 may have a groove (not shown), and the LED module may be inserted into the groove.

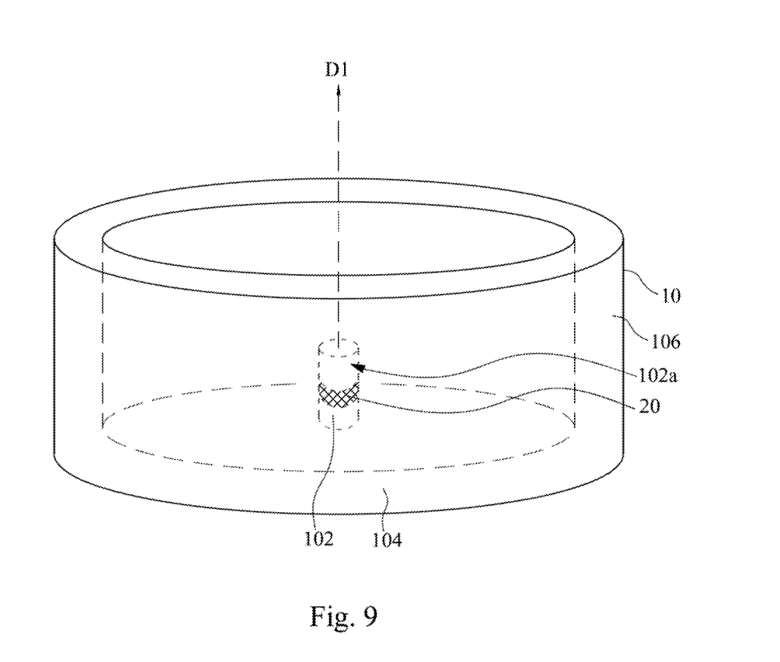

FIG. 9 is a stereoscopic view of a base according to another embodiment of the present disclosure. In the embodiment shown in FIG. 9, the side-emitting light source 20 is a ring-shaped light source. The central protrusion portion 102 is a cylinder extending in the axial direction D1 of the central protrusion portion 102. The side-emitting light source 20 may include a plurality of LEDs (not shown) disposed on a side surface 102a of the central protrusion portion 102 (i.e., the cylinder). That is, the LEDs are arranged in a ring form and surrounding the central protrusion portion 102

As mentioned above, the embodiment of the present disclosure provides a lamp structure having the first reflecting portion so as to resolve the problem of easily forming a dark band in the central region. Further, the base of the lamp structure may include a heat spreader so as to effectively help heat generated from the light source to dissipate. Therefore, the lamp structure of the embodiment of the present disclosure is able to uniformly emit light and to effectively help heat generated from the light source to dissipate.

Although the present disclosure has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present disclosure without departing from the scope or spirit of the disclosure. In view of the foregoing, it is intended that the present disclosure cover modifications and variations thereof provided they fall within the scope of the following claims.

What is claimed is:

1. A lamp structure, comprising:
a base including a central protrusion portion extending from the base;
a side-emitting light source disposed on a side surface of the central protrusion portion and configured to emit a light beam;
a first reflecting portion adjacent to the central protrusion portion, wherein the first reflecting portion includes a first reflective curved surface, and a portion of the light beam is reflected by the first reflective curved surface and then is directly emitted out in an light outgoing direction, and the light outgoing direction is substantially parallel to an axial direction of the central protrusion portion; and
a second reflecting portion, and the first reflecting portion is disposed between the central protrusion portion and the second reflecting portion, wherein the second reflecting portion includes a second reflective curved surface adjacent to the first reflective curved surface, and the other portion of the light beam is reflected by the second reflective curved surface and then is directly or indirectly emitted out,
wherein the first reflective curved surface has a radius of curvature less than a radius of curvature of the second reflective curved surface.

2. The lamp structure of claim 1, wherein the radius of curvature of the first effective curved surface is in a range from 2 cm to 10 cm.

3. The lamp structure of claim 1, wherein a lowest point of the first reflective curved surface of the first reflecting portion is higher than a lowest point of the second reflective curved surface of the second reflecting portion.

4. The lamp structure of claim 1, wherein the side-emitting light source is higher than a highest point of the first reflective curved surface of the first reflecting portion.

5. The lamp structure of claim 1, wherein a ratio of a distance between a lowest point of the first reflective curved surface and the side surface of the central protrusion portion to a distance between a highest point of the first reflective curved surface and the side surface of the central protrusion portion is lower than or equal to 0.7.

6. The lamp structure of claim 1, wherein an included angle between the portion of the light beam and a direction substantially vertical to the axial direction of the central protrusion portion is greater than or equal to a specific angle of 45°-60°.

7. The lamp structure of claim 1, wherein a highest point of the first reflective curved surface is disposed on an extension line with an included angle of 45°-60° to a main light emitting direction of the side-emitting light source.

8. The lamp structure of claim 1, wherein a lowest point of the first reflective curved surface is disposed on an extension line with an included angle greater than 60° to a main light emitting direction of the side-emitting light source.

9. The lamp structure of claim 1, wherein a tangent line of a lowest point of the first reflective curved surface of the first reflecting portion is substantially parallel to a direction vertical to the axial direction of the central protrusion portion.

10. The lamp structure of claim 1, wherein the first reflecting portion further comprises a back surface connected to a highest point of the first reflective curved surface.

11. The lamp structure of claim 1, wherein the second reflecting portion further comprises a third reflective curved surface connected to the second reflective curved surface, and the second reflective curved surface is disposed between the first reflective curved surface and the third reflective curved surface, and the third reflective curved surface has a radius of curvature greater than the radius of curvature of the second reflective curved surface.

12. The lamp structure of claim 1, wherein the side-emitting light source is a linear-shaped light source or a ring-shaped light source.

13. The lamp structure of claim 1, wherein the central protrusion portion is a longitudinal object extending in a direction vertical to the axial direction of the central protrusion portion, and the side-emitting light source comprises a plurality of light-emitting diodes disposed on two opposite longitudinal sides of the longitudinal object.

14. The lamp structure of claim 13, wherein the light-emitting diodes are arranged in a linear form along the extending direction of the longitudinal object.

15. The lamp structure of claim wherein the central protrusion portion is a cylinder extending in the axial direction of the central protrusion portion, and the side-emitting light source comprises a plurality of light-emitting diodes disposed on a side surface of the cylinder.

16. The lamp structure of claim 15, wherein the light-emitting diodes are arranged in a ring form and surrounding the central protrusion portion.

17. The lamp structure of claim 1, wherein the base further comprises a heat spreader connected to the central protrusion portion, and the heat spreader comprises a plurality of heat dissipation fins spaced apart.

18. The lamp structure of claim 17, wherein the heat spreader of the base and the central protrusion portion are integrally formed.

19. The lamp structure of claim 1, further comprising a high reflectivity layer covering the first reflective curved surface, the second reflective curved surface or a combination thereof.
